(19) United States
(12) Patent Application Publication
(10) Pub. No.: US 2009/0142114 A1
(43) Pub. Date: Jun. 4, 2009

(54) FIXING DEVICE

(75) Inventors: Akihiro Yasuda, Osaka (JP); Noboru Katakabe, Kyoto (JP); Koichi Baba, Osaka (JP); Shigemitsu Tani, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/719,569

(22) PCT Filed: Nov. 17, 2005
(86) PCT No.: PCT/JP05/21151

§ 371 Date: May 17, 2007

(30) Foreign Application Priority Data
Nov. 18, 2004 (JP) 2004-334996
Nov. 19, 2004 (JP) 2004-336529

(51) Int. Cl. G03G 15/20

(52) U.S. Cl. 399/333

(57) ABSTRACT

A fixing device enabling the temperature of a heating element to be uniformly and stably maintained even if the heating element is eccentrically moved or vibrated. An opposed core (233) is so formed that a small diameter opposed core (2332) is fixedly inserted onto the center part of a core shaft (2331) and large diameter opposed cores (2333) are fixedly inserted onto both end parts of the core shaft (2331) so that the cross sectional area thereof at both ends in the lateral direction (both ends in the longitudinal direction) is larger than the cross sectional area thereof at the center part in the lateral direction. A fixing belt (210) is formed of a non-magnetic material and disposed between a core (232) and the opposed core (233). Thus, since a magnetic flux between the core (232) and the opposed core (233) is not almost varied and the fixing belt (210) allows the magnetic flux to pass therethrough and does not affect the flux, even if the fixing belt (210) is rotated and a distance between the core (232) and the fixing belt (210) is varied, the temperature of the fixing belt (210) can be uniformly and stably maintained.

### TECHNICAL FIELD

The present invention relates to a fixing apparatus that fuses a non-fixed image formed on a recording medium onto the recording medium using an induction-heating type heating section, and more particularly, to a fixing apparatus useful for use in an image forming apparatus including for example, an electrophotographic or electrostatic recording copy machine, facsimile and printer.

### BACKGROUND ART

In an induction-heating (IH) type fixing apparatus, an eddy current is generated in a heating element by magnetic field, and by Joule heating of the heating element by the eddy current, a non-fixed image formed on a recording medium including, for example, a transfer sheet and OHP sheet is fused onto the recording medium.

Conventionally, as a fixing apparatus of this type, a heating apparatus is known that heats a rotational moving heating body, including, for example, a film-shaped sleeve and endless belt made of a thin magnetic material, by means of a magnetic flux generating means having a configuration where a coil is wound around a core made of, for example, iron, ferrite, permalloy or the like (for example, see patent document 1)

With the fixing apparatus using such a thin heating element with a small heat capacity, heat can be generated in a short time, and it is thus possible to remarkably enhance rise response characteristics where the heating element heats up to a predetermined fixing temperature.

However, in the fixing apparatus using such a heating element with a small heat capacity, a heat discharge value is larger in both end portions in the width direction that is perpendicular to the rotational moving direction of the heating element than in the center portion.

Therefore, in the fixing apparatus using such a thin heating element, the heating value at both end portions in the width direction of the heating element is lower than the predetermined fixing temperature, and lack of heating and lack of fixing tend to occur in non-fixed images formed on both end portions in the feeding direction of the recording medium.

In patent document 1, to compensate for such lack of heating due to heat radiation from the both end portions in the width direction of the heating element, by increasing the cross-sectional area of the both end portions in the width direction of the core around which the coil is wound, the magnetic flux is strengthen that acts on the both end portions in the width direction of the heating element.

### Patent Document 1: Japanese Patent Application Laid-Open No. 8-16005

### DISCLOSURE OF INVENTION

### Problems to be Solved by the Invention

However, with the fixing apparatus using such a heating element with a small heat capacity as described above, the heating element is configured to be thin, and the clearance between the heating element and the core tends to change according to decentering and vibration of the heating element during rotational moving.

Further, the heating element of this type of conventional fixing apparatus is made of a magnetic material, and the magnetic flux density per unit area increases as the clearance to the core decreases, and decreases as the clearance to the core increases.

Therefore, in this type of conventional fixing apparatus, the clearance between the heating element and core changes according to decentering and vibration of the heating element during rotational moving, a heating value of the heating element changes, and uneven temperatures tend to occur in the heating element.

Accordingly, in this type of conventional heating apparatus, when the cross-sectional area is increased at the both end portions in the width direction of the core around which the coil is wound to strengthen the magnetic flux that acts on the both end portions in the width direction of the heating element as described in patent document 1, there is a problem that heating further increases at the both end portions in the width direction of the heating element.

The present invention is carried out in view of the foregoing, and it is therefore an object of the present invention to provide a fixing apparatus capable of maintaining the temperature of a heating element uniformly and stably even when the heating element is decentered and vibrates.

### Means for Solving the Problem

To solve the problem, a fixing apparatus of the present invention adopts a configuration having: a magnetic flux generating section that generates a magnetic flux using a coil wound around a core made of a magnetic material; an opposite core that is disposed opposite to the core and forms a magnetic path to the core; a heating element made of a non-magnetic material that moves in an across direction of the magnetic path and is induction-heated; and a magnetic flux enhancement section that enhances the magnetic flux at both end portions in a width direction higher than the magnetic flux in a center portion in the width direction perpendicular to a moving direction of the heating element. Further, the fixing apparatus of the present invention adopts a configuration having: a magnetic flux generator that generates a magnetic flux using a coil wound around a core made of a magnetic material; an opposite core that is disposed opposite the core to form a magnetic path to the core; and heating element made of a non-magnetic material that moves in an across direction of the magnetic path to be induction-heated, wherein the magnetic flux generating section and the opposite core have sizes to heat a maximum paper pass region of the heating element through which a maximum size recording medium is passed to a fixing temperature within a predetermined range.

### ADVANTAGEOUS EFFECT OF THE INVENTION

According to the present invention, since the heating element is made of a non-magnetic material through which a magnetic flux passes, changes in the clearance between the heating element and core due to decentering and vibration of the heating element do not have an adverse influence on heating of the heating element, thereby maintaining the temperature of the heating element uniformly and stably.

### BRIEF DESCRIPTION OF DRAWINGS

FIG. 1 is a schematic cross-sectional view illustrating the entire configuration of an image forming apparatus suitable for being installed with a fixing apparatus according to embodiments of the present invention;

FIG. 2 is a cross-sectional view explaining a basic configuration of the fixing apparatus according to the embodiments of the present invention;

FIG. 3 is a schematic cross-sectional view illustrating a configuration of a fixing apparatus according to Embodiment 1 of the present invention;

FIG. 4 is a schematic cross-sectional view of principal part of the fixing apparatus according to Embodiment 1 of the present invention taken along line X-X shown in FIG. 3;

FIG. 5 is a schematic cross-sectional view illustrating a configuration of principal part of a fixing apparatus according to Embodiment 2 of the present invention;

FIG. 6 is a schematic cross-sectional view illustrating a configuration of principal part of a fixing apparatus according to Embodiment 3 of the present invention;

FIG. 7 is a schematic cross-sectional view illustrating a configuration of a fixing apparatus according to Embodiment 4 of the present invention;

FIG. 8 is a schematic cross-sectional view illustrating a configuration of a fixing apparatus according to Embodiment 5 of the present invention;

FIG. 9 is a schematic cross-sectional view illustrating a magnetic shield disposed in an opposite core and rotated to a withdrawal position in the fixing apparatus according to Embodiment 5 of the present invention;

FIG. 10 is a schematic cross-sectional view of principal part of the fixing apparatus according to Embodiment 5 of the present invention taken along line Y-Y shown in FIG. 9;

FIG. 11 is a schematic cross-sectional view illustrating a configuration of principal part of a fixing apparatus according to Embodiment 6 of the present invention;

FIG. 12 is a schematic cross-sectional view illustrating a configuration of principal part of a fixing apparatus according to Embodiment 7 of the present invention;

FIG. 13 is a schematic cross-sectional view illustrating a configuration of a fixing apparatus according to Embodiment 8 of the present invention;

FIG. 14 is a schematic cross-sectional view illustrating a magnetic shield disposed in an opposite core and rotated to a withdrawal position in the fixing apparatus according to Embodiment 8 of the present invention; and

FIG. 15 is a schematic cross-sectional view of principal part of the fixing apparatus according to Embodiment 8 of the present invention taken along line Z-Z shown in FIG. 14.

### BEST MODE FOR CARRYING OUT THE INVENTION

Embodiments of the present invention will be described in detail below with reference to the accompanying drawings. In addition, in each figure, components and equivalent portions that have the same configurations or functions are assigned the same codes and their descriptions are not repeated.

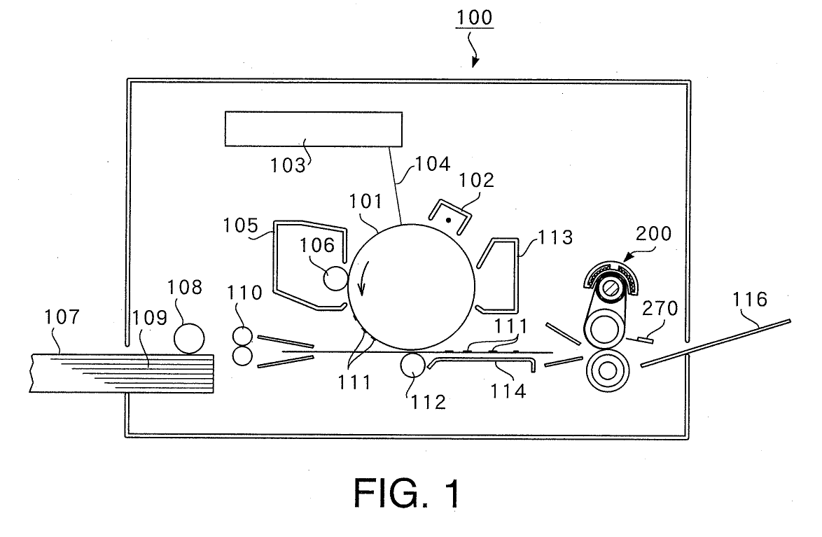

First, an image forming apparatus suitable for being installed with a fixing apparatus according to the embodiments of the present invention. FIG. 1 is a schematic cross-sectional view illustrating the entire configuration of an image forming apparatus suitable for being installed with a fixing apparatus according to the embodiments of the present invention.

As shown in FIG. 1, image forming apparatus 100 has an electrophotosensitive material (hereinafter, referred to as a “photosensitive drum”) 101; electrifier 102; laser beam scanner 103; development device 105; paper feeding apparatus 107; cleaning apparatus 113; fixing apparatus 200 and the like.

In FIG. 1, photosensitive drum 101 is driven to rotate in the direction of the arrow at a predetermined circumferential speed, and the surface of the photosensitive drum 101 is charged uniformly at predetermined negative dark potential by electrifier 102.

Laser beam scanner 103 outputs laser beam 104 modulated according to a time-series electric digital pixel signal of image information input from a host apparatus such as an image reading apparatus, computer (not shown) or the like, and scans and exposes the uniformly charged surface of the photosensitive drum 101 by laser beam 104. By this means, a potential absolute value at exposed portions of photosensitive drum 101 decreases and becomes bright potential, and an electrostatic latent image is formed on the surface of photosensitive drum 101.

Development device 105 has developing roller 106 to be driven to rotate. Developing roller 106 is disposed opposite to photosensitive drum 101, and a thin layer of toner is formed on the outer circumferential surface of developing roller 106. A developing bias voltage, in which the absolute value is lower than the dark potential of photosensitive drum 101 and higher than the bright potential, is applied to developing roller 106.

By this means, the negatively charged toner on developing roller 106 adheres to only portions of the bright potential on the surface of photosensitive drum 101, the electrostatic latent image formed on the surface of photosensitive drum 101 is inverted and developed to form an image, and non-fixed toner image 111 is formed on photosensitive drum 101.

Meanwhile, paper feeding apparatus 107 feeds recording paper 109 as a recording medium per sheet at predetermined timing using paper feeding roller 108. The recording paper 109 fed from paper feeding apparatus 107 is passed through a pair of resist rollers 110, and sent to a nip portion between photosensitive drum 101 and transfer roller 112 at appropriate timing synchronized with rotation of photosensitive drum 101. The non-fixed toner image 111 on photosensitive drum 101 is thus transferred to recording paper 109 by transfer roller 112 to which a transfer bias is applied.

Recording paper 109 on which the non-fixed toner image 111 thus is transferred is guided by recording paper guide 114 and separated from photosensitive drum 101, and fed toward a fixing portion of fixing apparatus 200. Fixing apparatus 200 fuses the non-fixed toner image 111 onto the recording paper 109 fed to the fixing portion.

Recording paper 109 on which the non-fixed toner image 111 is fused passes through fixing apparatus 200, and is discharged onto output tray 116 disposed outside image forming apparatus 100.

Meanwhile, in photosensitive drum 101 from which recording paper 109 is separated, residues such as a transfer toner residue and the like on the surface are removed by cleaning apparatus 113, and photosensitive drum 101 is used for subsequent image formation repeatedly.

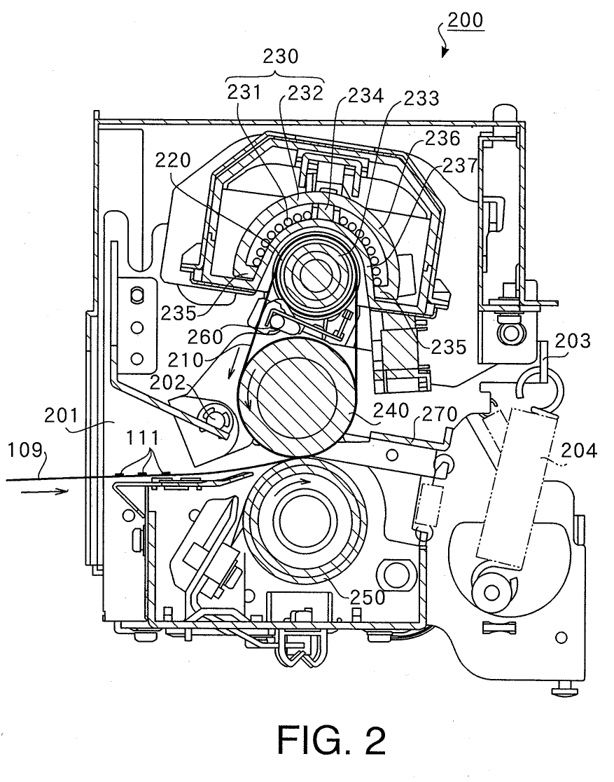

Next, the fixing apparatus installed in image forming apparatus 100 as described above will be described. FIG. 2 is a cross-sectional view explaining a basic configuration of the fixing apparatus according to the embodiments of the present invention.

As shown in FIG. 2, this fixing apparatus 200 has: fixing belt 210 as a heating element; support roller 220 as a belt supporting member; excitation device 230 as an induction heating means; fixing roller 240; pressure roller 250 as a belt rotating means, and the like.

In FIG. 2, fixing belt 210 is extended between support roller 220 and fixing roller 240. Support roller 220 is rotatably supported on the upper side of main body side plate 201 of fixing apparatus 200. Fixing roller 240 is rotatably supported by rocking plate 203 attached rotatably to main body side plate 201 by short axis 202. Pressure roller 250 is rotatably supported on the lower side of main body side plate 201 of fixing apparatus 200.

Rocking plate 203 rocks in a clockwise direction around short axis 202 as a center by contraction behavior of coil spring 204. Fixing roller 240 changes positions according to the rocking of rocking plate 203, and by the change, comes onto contact with pressure roller 250 by pressuring with fixing belt 210 therebetween. Support roller 220 is pressed to the opposite side to fixing roller 240 by a spring (not shown), and predetermined tension is thereby applied to fixing belt 210.

Pressure roller 250 is driven to rotate in the direction of the arrow by a driving source (not shown) Fixing roller 240 holds fixing belt 210 and rotates according to the rotation of pressure roller 250. Fixing belt 210 is thereby held between fixing roller 240 and pressure roller 250 and rotated in the direction of the arrow. By the rotation of fixing belt 210, a nip portion to fuse the non-fixed toner image 111 onto the recording paper 109 is formed between fixing belt 210 and pressure roller 250.

Excitation device 230 is comprised of an IH means as described above, and as shown in FIG. 2, has excitation coil 231 as a magnetic flux generating means disposed along the outer circumference surface of fixing belt 210 in a portion extended around support roller 220, and core 232 made of ferrite covering excitation coil 231. Excitation coil 231 extends in the width direction of passed paper, and is folded and wound along the transfer direction of fixing belt 210. Further, inside support roller 220 is provided with opposite core 233 made of ferrite and opposite to excitation coil 231 with fixing belt 210 and support roller 220 in between.

Core 232 is comprised of center core 234, side cores 235 and arch core 236. Center core 234 is disposed (or formed integrally) in the center portion of arch core 236. Side cores 235 are made of a pair of ferrite, and disposed (or formed integrally) at both ends of arch core 236.

As a material for core 232 and opposite core 233, materials with high magnetic permeability such as permalloy and the like may be used as well as ferrite.

Excitation coil 231 is formed using a litz wire that is a bundle of thin wires, and has a semicircular cross-sectional shape formed to cover the outer circumferential surface of fixing belt 210 extended over support roller 220.

An excitation current with a driving frequency of 30 kHz is applied to excitation coil 231 from an excitation circuit (not shown). An alternating magnetic field is thereby generated between core 232 and opposite core 233, and an eddy current is generated in a conductive layer of fixing belt 210 as a heating element, and fixing belt 210 thereby produces heat. In addition, although with this example the configuration having fixing belt 210 as a heating element, another configuration may be adopted where support roller 220 is used as a heating element, and heat of support roller 220 is conducted to fixing belt 210.

This fixing apparatus 200 is, as shown in FIG. 2, able to fuse non-fixed toner image 111 onto recording paper 109 by feeding recording paper 109 on which non-fixed toner image 111 is transferred from the direction of the arrow so that the bearing surface of non-fixed toner image 111 is in contact with fixing belt 210.

In addition, on the back side of fixing belt 210 at the position past a contact portion with support roller 220, temperature sensor 260 comprised of a thermostat is provided so as to be in contact with fixing belt 210. This temperature sensor 260 detects temperatures of fixing belt 210. An output of temperature sensor 260 is provided to a control apparatus (not shown). Based on the output of temperature sensor 260, the control apparatus controls power to be supplied to excitation coil 231 via the excitation circuit so as to set the optimal image fixing temperature, and thereby controls a heating value of fixing belt 210.

Further, in a portion where fixing belt 210 is extended over fixing roller 240 on the downstream side in the feeding direction of recording paper 109, output guide 270 is provided that guides recording paper 109 fusing toward output tray 116.

Furthermore, excitation device 230 is provided with coil guide 237 as a holding member integrated with excitation coil 231 and core 232. This coil guide 237 is made of a resin with high heat resistance temperature including, for example, PEEK material and PPS. Coil guide 237 avoids damage to excitation coil 231 which would be caused by heat radiated from fixing belt 210 staying in space between fixing belt 210 and excitation coil 231.

In addition, although core 232 shown in FIG. 2 has the semicircular cross section, this core 232 does not need to always have a shape along with the shape of excitation coil 231, and the shape of the cross section may be a general π-shape.

Fixing belt 210 is made of a thin endless belt with a diameter of 50 mm and a thickness of 50 μm where the conductive layer is formed by dispersing silver powder in a base material that is a polyimide resin with a glass transition temperature of 360 degrees. The conductive layer may adopt a configuration where two or three silver layers of a thickness of 10 μm are laminated. Further, to provide releasability, a release layer (not shown) of a thickness of 5 μm made of a fluororesin may coat on the surface of this fixing belt 210. The glass transition temperature of the base material of fixing belt 210 is preferably within the range of 200 degrees to 500 degrees. Further, as the release layer on the surface of fixing belt 210, a resin or rubber such as PTFE, PFA, FEP, silicon rubber, fluororubber and the like with excellent releasability may be used alone or in a combination.

In addition, as a material of the base material of fixing belt 210, the above-mentioned polyimide resin, and, in addition, resins with heat resistance including, for example, a fluororesin and metal such as a stainless thin plate may be used. For example, this fixing belt 210 may have a configuration where silver plating of a thickness of 10 μm is made on the surface of SUS304 (non-magnetic) of a thickness of 40 μm.

Further, as described later, in order for fixing belt 210 not to have an influence on the magnetic flux between core 232 and opposite core 233, the magnetic flux needs to pass through fixing belt 210. Therefore, fixing belt 210 is preferably made of a non-magnetic material such as silver, copper and the like.

Furthermore, when fixing belt 210 is used as an image heating element for fusing of a monochrome image, only releasability needs to be secured. However, when fixing belt 210 is used as an image heating element for fusing of a color image, it is desired to form a thick rubber layer to provide elasticity. The heat capacity of fixing belt 210 is preferably 60 J/K or less, and more preferably, 40 J/K or less.

Support roller 220 is comprised of a cylindrical metal roller of a diameter of 20 mm, a length of 320 mm, and a thickness of 0.2 mm. In addition, as a material for support roller 220, non-magnetic materials that are easy to transmit a magnetic flux are preferable. Further, preferably, a material is less likely to generate an eddy current, and a non-magnetic stainless material with specific resistance of 50 μΩcm or greater is preferably used. Incidentally, since support roller 220 made of SUS304 that is the non-magnetic stainless material is high in specific resistance with 72 μΩcm and non-magnetic, the magnetic flux passed through support roller 220 is not shielded so much, and for example, heating of support roller 220 of a thickness of 0.2 mm is extremely small. Further, support roller 220 made of SUS304 is high in mechanical strength, so that it is possible to thin support roller 220 to a thickness of 0.04 mm to further decrease the heat capacity, and thus is suitable for fixing apparatus 200 of this configuration. Furthermore, as support roller 220, relative permeability is preferably 4 or less, and the thickness is preferably within the range of 0.04 mm to 0.2 mm.

Fixing roller 240 is made of a silicon rubber that is a foam having a surface of low hardness (herein, JISA 30 degrees), a diameter of 30 mm and elasticity with low thermal conductivity.

Pressure roller 250 is made of a silicon rubber with a hardness of JISA 65 degrees. Thermal resistant resins and other rubbers such as a fluororubber, fluororesin and the like may be used as a material for this pressure roller 250. Further, it is desirable that a resin such as PFA, PTFE, FEP and the like or rubber is coated alone or in a combination on the surface of pressure roller 250 to enhance abrasion resistance and releasability. Furthermore, pressure roller 250 is preferably made of a material with low thermal conductivity.

### EMBODIMENT 1

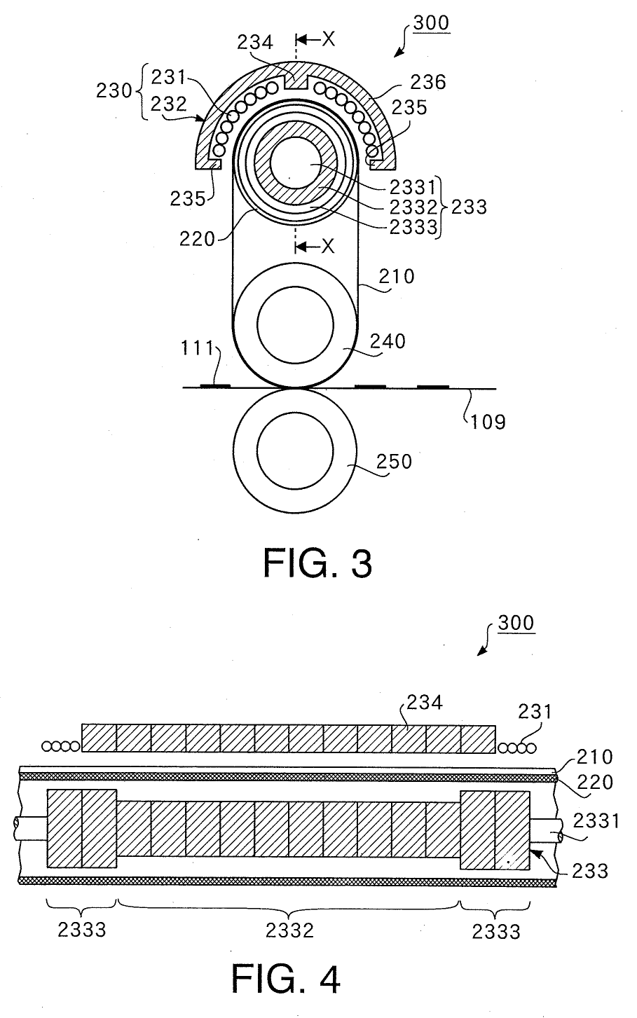

Next, the fixing apparatus according to Embodiment 1 of the present invention will be described. FIG. 3 is a schematic cross-sectional view illustrating a configuration of the fixing apparatus according to Embodiment 1 of the present invention. FIG. 4 is a schematic cross-sectional view of principal part of the fixing apparatus according to Embodiment 1 of the present invention taken along line X-X shown in FIG. 3.

As shown in FIGS. 3 and 4, fixing apparatus 300 according to Embodiment 1 has: fixing belt 210 as a heating element; support roller 220 as a belt supporting member; excitation device 230 as an induction heating means; fixing roller 240; pressure roller 250; and the like.

Excitation device 230 is comprised of: excitation coil 231 as a magnetic flux generating means; core 232 comprised of ferrite covering excitation coil 231; and opposite core 233 comprised of ferrite and opposite to excitation coil 231 with fixing belt 210 and support roller 220 held in between. Core 232 is comprised of center core 234, side cores 235 and arch core 236.

Fixing belt 210 in fixing apparatus 300 according to Embodiment 1 is made of a non-magnetic material. When thinned to about 10 μm, the non-magnetic material including, for example, copper and silver increases electric resistance, and effectively produces heat by induced current. Further, fixing belt 210 is the non-magnetic material, and therefore, transmits a magnetic flux.

Opposite core 233 in this fixing apparatus 300 is configured so that the cross-sectional area at both end portions in the width direction (both end portions in the longitudinal direction) is larger than the cross-sectional area of the center portion in the width direction.

As shown in FIGS. 3 and 4, for example, such opposite core 233 is formed by inserting a small-diameter opposite core 2332 with a small outer diameter in the form of a doughnut into a center portion of a core axis 2331, and further inserting a large-diameter opposite core 2333 with a large outer diameter in the form of a doughnut into both end portions of the core axis 2331.

Thus, in fixing apparatus 300 according to Embodiment 1, as a magnetic flux enhancing means for enhancing the magnetic flux acting on both end portions in the width direction to be higher than the magnetic flux acting on the center portion in the width direction perpendicular to the moving direction of fixing belt 210 as a heating element, such a configuration is adopted where the cross-sectional area at both end portions in the width direction of opposite core 233 is made larger than the cross-sectional area in the center portion in the width direction to enhance the magnetic flux at the both end portions in the width direction by a combination of small-diameter opposite core 2332 and large-diameter opposite core 233.

As described above, fixing apparatus 300 according to Embodiment 1 is configured to have the larger cross-sectional area at the both end portions in the width direction (both end portions in the longitudinal direction) of opposite core 233 than the cross-sectional area in the center portion in the width direction, so that it is thus possible to enhance the magnetic flux acting on the both end portions in the width direction of fixing belt 210. The heating value thereby increases at the both end portions in the width direction of fixing belt 210. In other words, reductions in temperature due to heat radiation from the both end portions in the width direction of fixing belt 210 are compensated, and the temperature distribution in the longitudinal direction of fixing belt 200 is uniformed.

Further, fixing belt 210 transmits a magnetic flux, so that it is possible to arrange opposite core 233 on the side opposite to excitation coil 231 with respect to fixing belt 210. It is thereby possible to obtain a strong magnetic flux between core 232 and opposite core 233, each using ferromagnetic ferrite.

Herein, in fixing belt 210, the clearance with core 232 tends to change due to decentering in rotation and the like. In contrast to this, core 232 and opposite core 233 are fixed to respective predetermined positions, and do not change relative positions.

Accordingly, with fixing apparatus 300 according to Embodiment 1, the magnetic flux between core 232 and opposite core 233 hardly changes, fixing belt 210 transmits the magnetic flux and does not change the magnetic flux, so that the magnetic flux penetrating fixing belt 210 does not change. In other words, when fixing belt 210 rotates and the clearance between core 232 and fixing belt 210 changes, fixing belt 210 is able to maintain a predetermined heating value stably.

Although with the conventional example, since a path of the magnetic flux generated around the coil is configured with the core and heating element, the magnetic flux changes according to positions of the heating element, with the present invention, since a path of the magnetic flux is configured with core 232 and opposite core 233, the magnetic flux is constant irrespective of positions of the heating element (fixing belt 210), and stable heat can be obtained.

Thus, with fixing apparatus 300 according to Embodiment 1, by means of the configuration where non-magnetic fixing belt 210 is disposed between core 232 and opposite core 233 and the magnetic flux is increased that acts on the both end portions in the width direction of fixing belt 210, it is possible to maintain uniform temperature distribution and constant temperature in the longitudinal direction of fixing belt 210, thereby obtaining stable fixing characteristics.

Further, this fixing apparatus 300 is able to uniformanize the temperature distribution in the longitudinal direction of fixing belt 210 without making the length in the width direction of opposite core 233 more than the width of the maximum size paper beyond necessity. Therefore, it is possible to make lengths in the width direction of core 232 and opposite core 233 almost the same length as the width of the maximum size paper and avoid increases in size of the apparatus body.

Furthermore, with this fixing apparatus 300, the diameter of both end portions 2333 of opposite core 233 in opposite position of coil 231 are increased, so that, in contrast to the configuration where the diameter of both end portions of center core 234 is increased, it is possible to increase versatility in a structure, thereby enabling an easy apparatus configuration.

### EMBODIMENT 2

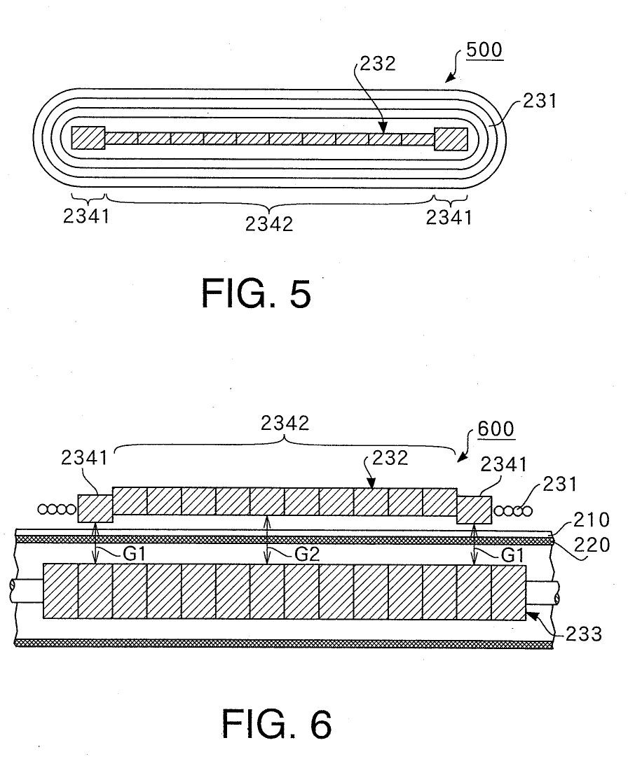

Next, a fixing apparatus according to Embodiment 2 of the present invention will be described. FIG. 5 is a schematic cross-sectional view illustrating a configuration of principal part of the fixing apparatus according to Embodiment 2 of the present invention.

With fixing apparatus 500 according to Embodiment 2 as a magnetic flux enhancing means, such a configuration is adopted where the cross-sectional area at both end portions in the width direction of core 232 is made larger than the cross-sectional area in the center portion in the width direction to enhance the magnetic flux at the both end portions in the width direction.

In other words, in this example, as shown in FIG. 5, a configuration is adopted where the cross-sectional area of center cores 2341 at both end portions in the width direction of center core 234 (see FIG. 4) is made larger than the cross-sectional area of center core 2342 in the center portion in the width direction to enhance the magnetic flux at the both end portions in the width direction of core 232.

With this fixing apparatus 500, a configuration is adopted where the cross-sectional area at both end portions in the width direction (both end portions in the longitudinal direction) of core 232 is made larger than the cross-sectional area in the center portion in the width direction, so that it is possible to increase the magnetic flux acting on both end portions in the width direction of fixing belt 210.

Further, like fixing belt 210 according to Embodiment 1, fixing belt 210 (see FIG. 4) of this fixing apparatus 500 is made of a non-magnetic material through which the magnetic flux is passed, the magnetic flux between core 232 and opposite core 233 hardly changes even when fixing belt 210 rotates and the clearance between core 232 and fixing belt 210 changes, so that it is possible to maintain a predetermined heating value of fixing belt 210 stably.

Furthermore, like fixing apparatus 300 (see FIG. 3) according to Embodiment 1, with this fixing apparatus 500, the magnetic flux acting on the both end portions in the width direction of fixing belt 210 is increased to suppress decreases in temperature due to heat radiation from the both end portions in the width direction of fixing belt 210, so that the temperature distribution in the longitudinal direction of fixing belt 210 is made uniform, thereby obtaining stable fixing characteristics.

Still furthermore, with this fixing apparatus 500, it is possible to make lengths of core 232 and opposite core 233 in the width direction almost the same as the width of the maximum size paper and avoid increases in size of the apparatus body.

In addition, although with this fixing apparatus 500, the example has been described where center cores 2341 at the both end portions in the width direction are increased in the moving direction of fixing belt 210, this is by no means limiting, and the same effect is obtained in the case that center cores 2341 at the both end portions in the width direction are increased in the direction perpendicular to the moving direction of fixing belt 210.

### EMBODIMENT 3

Next, a fixing apparatus according to Embodiment 3 of the present invention will be described. FIG. 6 is a schematic cross-sectional view illustrating a configuration of principal part of the fixing apparatus according to Embodiment 3 of the present invention.

As shown in FIG. 6, with fixing apparatus 600 according to Embodiment 3 as a magnetic flux enhancing means, such a configuration is adopted where gap G1 between both end portions is made smaller than gap G2 between center portions in the width direction of core 232 and opposite core 233 to enhance the magnetic flux at the both end portions in the width direction.

In other words, with this example, a configuration is adopted where center cores 2341 at the both end portions in the width direction of center core 234 are provided in position closer to opposite core 233 than center core 2342 in the center portion in the width direction to enhance the magnetic flux at the both end portions in the width direction.

This fixing apparatus 600 is configured so that gap G1 between both end portions is made smaller than gap G2 between center portions in the width direction of core 232 and opposite core 233, so that it is able to enhance the magnetic flux acting on the both end portions in the width direction of fixing belt 210.

Further, like fixing belt 210 of fixing apparatus 300 according to Embodiment 1, fixing belt 210 of this fixing apparatus 600 is made of a non-magnetic material through which the magnetic flux is passed, and the magnetic flux between core 232 and opposite core 233 hardly changes even when fixing belt 210 rotates and the clearance between core 232 and fixing belt 210 changes, so that it is possible to maintain a predetermined heating value of fixing belt 210 stably.

Furthermore, like fixing apparatus 300 according to Embodiment 1, with this fixing apparatus 600, the magnetic flux acting on the both end portions in the width direction of fixing belt 210 is increased to suppress decreases in temperature due to heat radiation from the both end portions in the width direction of fixing belt 210, so that the temperature distribution in the longitudinal direction of fixing belt 210 is made uniform, thereby obtaining stable fixing characteristics.

Still furthermore, with this fixing apparatus 600, it is possible to make lengths in the width direction of core 232 and opposite core 233 almost the same length as the length of the width of the maximum size paper, and avoid increases in size of the apparatus body.

### EMBODIMENT 4

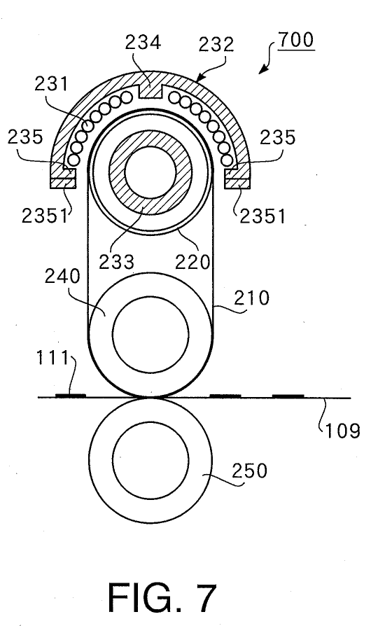

Next, a fixing apparatus according to Embodiment 4 of the present invention will be described. FIG. 7 is a schematic cross-sectional view illustrating a configuration of the fixing apparatus according to Embodiment 4 of the present invention.

With fixing apparatus 700 according to Embodiment 4, as a magnetic flux enhancing means, such a configuration is adopted where the cross-sectional area at both end portions in the width direction of side cores 235 is made larger than the cross-sectional area in the center portion in the width direction to enhance the magnetic flux at the both end portions in the width direction.

In other words, in this example, as shown in FIG. 7, a configuration is adopted where supplemental side cores 2351 for magnetic flux enhancement are provided at both end portions in the width direction of side cores 235, and the cross-sectional area at the both end portions in the width direction of side cores 235 is made larger than the cross-sectional area in the center portion in the width direction to enhance the magnetic flux at the both end portions in the width direction of core 232.

This fixing apparatus 700 is configured so that the cross-sectional area at the both end portions of side cores 235 (both end portions in the longitudinal direction) is made larger than the cross-sectional area in the center portion in the width direction, so that it is able to increase the magnetic flux acting on the both end portions in the width direction of fixing belt 210.

Further, like in fixing belt 210 of fixing apparatus 300 according to Embodiment 1, fixing belt 210 of this fixing apparatus 700 is made of a non-magnetic material through which the magnetic flux is passed, and the magnetic flux between core 232 and opposite core 233 hardly changes when fixing belt 210 rotates and the clearance between core 232 and fixing belt 210 changes, so that it is possible to maintain a predetermined heating value of fixing belt 210 stably.

Furthermore, like fixing apparatus 300 according to Embodiment 1, with this fixing apparatus 700, the magnetic flux acting on the both end portions in the width direction of fixing belt 210 is increased to suppress decreases in temperature due to heat radiation from the both end portions in the width direction of fixing belt 210, so that the temperature distribution in the longitudinal direction of fixing belt 210 is made uniform, thereby obtaining stable fixing characteristics.

Still furthermore, with this fixing apparatus 700, it is possible to make lengths of core 232 and opposite core 233 almost the same length as the width of the maximum size paper and avoid increases in size of the apparatus body.

### EMBODIMENT 5

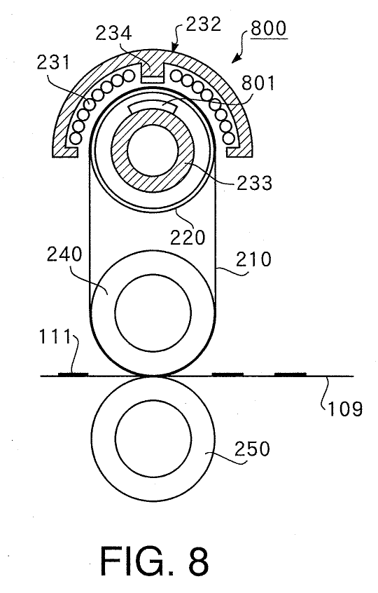

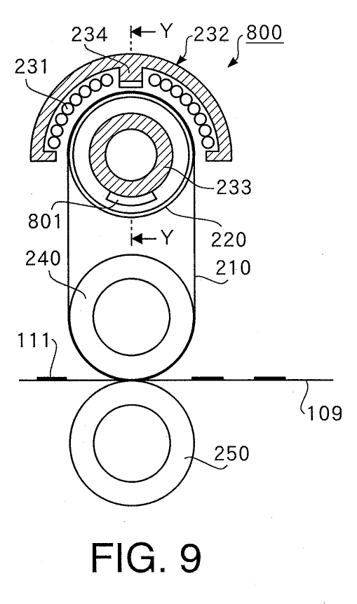

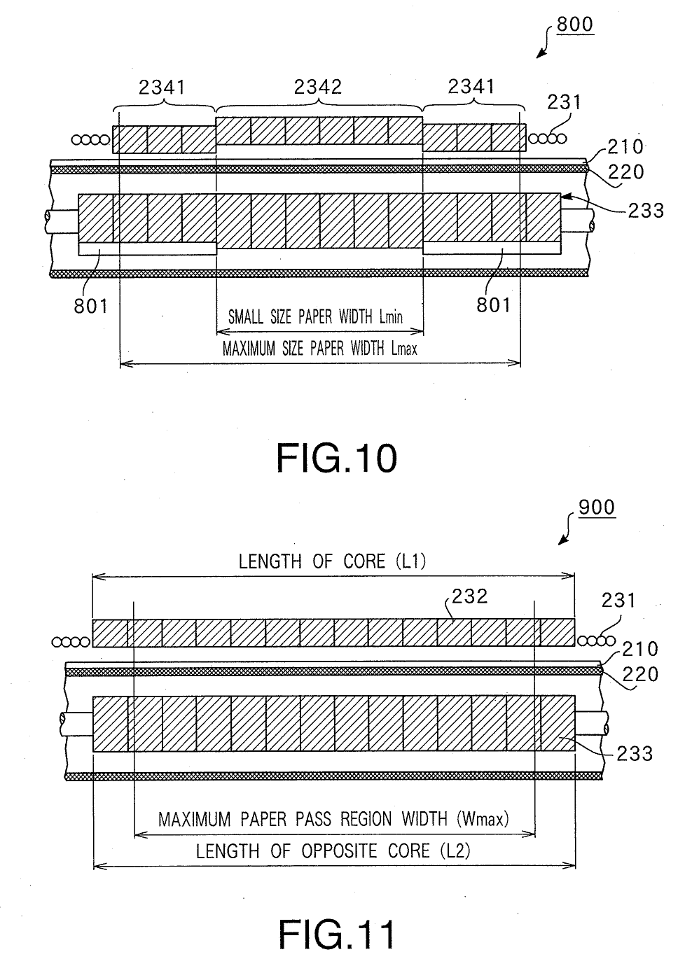

Next a fixing apparatus according to Embodiment 5 of the present invention will be described. FIG. 8 is a schematic cross-sectional view illustrating a configuration of the fixing apparatus according to Embodiment 5 of the present invention. FIG. 9 is a schematic cross-sectional view illustrating a magnetic shield which is disposed in an opposite core and rotated to a withdrawal position in the fixing apparatus according to Embodiment 5 of the present invention. FIG. 10 is a schematic cross-sectional view of principal part of the fixing apparatus according to Embodiment 5 of the present invention taken along line Y-Y shown in FIG. 9.

As shown in FIGS. 8, 9 and 10, fixing apparatus 800 according to Embodiment 5 adopts a configuration where magnetic shield 801 that shields the magnetic flux corresponding to a non-paper pass region in small size paper of fixing belt 210 is disposed in part of the outer periphery of opposite core 233.

Magnetic shied 801 of this example is made of a conductive member including, for example, copper of a thickness of 1 mm and is able to change positions between a shield position to shield a magnetic path between center core 234 and opposite core 233 as shown in FIG. 8 and a withdrawal position for withdrawal from the magnetic path as shown in FIG. 9, by rotation of opposite core 233 by a driving means (not shown).

Here, as shown in FIG. 10, center core 234 is formed to have a length corresponding to the width of maximum paper size (for example, the width of A3 size recording paper) Lmax. Further, magnetic shield 801 has a length where the magnetic flux acting on the non-paper pass region of fixing belt 210 can be shielded when recording paper 109 having the width of small size paper (for example, the width of A4 size recording paper) Lmin is passed through a nip portion between fixing belt 210 and pressure roller 250.

With fixing apparatus 800 of this example, only by rotating opposite core 233, it is possible to switch the width in the longitudinal direction of the magnetic path between center core 234 and opposite core 233 between the width of maximum size paper Lmax and the width of small size paper Lmin, so that it is possible to support the width of recording paper 109 passed through the heating width of fixing belt 210 without difficulty.

However, with fixing apparatus 800 having above-mentioned magnetic shield 801, when recording paper 109 having the width of the maximum size paper is passed through (FIG. 9), heat is transferred from support roller 220 to magnetic shield 801, and there is therefore a tendency that the temperatures at both ends in the paper pass region corresponding to magnetic shield 801 is lower than the temperature in the center of the paper pass region that does not correspond to magnetic shield 801.

Then, with fixing apparatus 800 of this example, as shown in FIG. 10, center core 2341 in the portions opposite to magnetic shield 801 is disposed in the position closer to opposite core 233 than center core 2342 in the position that is not opposite to magnetic shield 801.

Thus, with fixing apparatus 800 of this example, the gap between core 232 and opposite core 233 in portions corresponding to the position of magnetic shield 801 is narrowed, so that the heating value of fixing belt 210 in portions corresponding to the position of magnetic shield 801 is increased, thereby compensating for decreases in temperature due to magnetic shield 801 and uniforming the heating temperature of fixing belt 210.

In addition, although with Embodiment 5 of the present invention, the example has been described where center cores 2341 are brought close to opposite core 233 to enhance the magnetic flux, this is by no means limiting, and the magnetic flux may be enhanced in any one of configurations of Embodiment 1 to Embodiment 3. A fixing apparatus according to a first aspect according to the above-mentioned Embodiments adopts a configuration provided with: a magnetic flux generating means that generates a magnetic flux using a coil wound around a core made of a magnetic material; an opposite core that is disposed opposite to the core to form a magnetic path to the core; a heating element made of a non-magnetic material that moves in an across direction of the magnetic path to be induction-heated; and a magnetic flux enhancement section that enhances the magnetic flux at both end portions in the width direction higher than the magnetic flux in the center portion in the width direction perpendicular to a moving direction of the heating element. In the above-mentioned configuration, a fixing apparatus according to a second aspect according to the above-mentioned embodiments adopts a configuration where a magnetic shield that shields the magnetic flux corresponding to a non-paper pass region of the heating element is disposed in the opposite core, and the magnetic flux enhancement section enhances the magnetic flux in a portion where the magnetic shield is disposed. In the above-mentioned configuration, with a fixing apparatus according to a third aspect according to the above-mentioned embodiments, the magnetic flux enhancement section has a configuration where the cross-sectional area at both end portions in the width direction of the opposite core is made larger than the cross-sectional area in the center portion in the width direction thereof to enhance the magnetic flux at the both end portions in the width direction. In the above-mentioned configuration, with a fixing apparatus according to a fourth aspect according to the above-mentioned embodiments, the core has a center core disposed in a center portion of the coil, and the magnetic flux enhancement section has a configuration where the cross-sectional area at both end portions in the width direction of the center core is made larger than the cross-sectional area in the center portion in the width direction of the center core to enhance the magnetic flux at the both end portions in the width direction. In the above-mentioned configuration, with a fixing apparatus according to a fifth aspect according to the above-mentioned embodiments, the magnetic flux enhancement section has a configuration where the gap between both end portions in the width direction of the core and the opposite core is made smaller than the gap between the center portion in the width direction of the core and the opposite core to enhance the magnetic flux at the both end portions in the width direction. In the above-mentioned configuration, with a fixing apparatus according to a sixth aspect according to the above-mentioned embodiments, the core has a pair of side cores disposed in opposite side portions of the coil, and the magnetic flux enhancement section has a configuration where the cross-sectional area at both end portions in the width direction of the side cores is made larger than the cross-sectional area in the center portion in the width direction of the side cores to enhance the magnetic flux at the both end portions in the width direction. In the above-mentioned configuration, a fixing apparatus according to a seventh aspect according to the above-mentioned embodiments adopts a configuration where the heating element is formed in the shape of a ring, and the coil is disposed in an outer circumferential portion of the heating element. In the above-mentioned configuration, a fixing apparatus according to an eighth aspect according to the above-mentioned embodiments adopts a configuration where in the state where the coil is opposite to the heating element, inductance of the coil at a frequency of 30 kHz ranges from 10 μH to 50 μH, and electric resistance ranges from 0.5Ω to 5Ω. In the above-mentioned configuration, a fixing apparatus according to a ninth aspect according to the above-mentioned embodiments adopts a configuration where a frequency of a current applied to the coil ranges from 20 kHz to 100 kHz. An image forming apparatus according to a tenth aspect of the above-mentioned embodiments is an image forming apparatus provided with a fixing section that fixes a non-fixed image formed on a recording medium, and adopts a configuration where the fixing apparatus with the above-mentioned configuration is used as the fixing section.

### EMBODIMENT 6

Next, a fixing apparatus according to Embodiment 6 of the present invention will be described. FIG. 11 is a schematic cross-sectional view illustrating a configuration of principal part of the fixing apparatus according to Embodiment 6 of the present invention.

With fixing apparatus 900 according to Embodiment 6, core 232 around which excitation coil 231 is wound as a magnetic flux generating means and opposite core 233 have the sizes to heat a maximum paper pass region of fixing belt 210 as a heating element through which recording paper 109 of a maximum size (for example, A3 size) is passed to a fixing temperature within a predetermined range.

More specifically, as shown in FIG. 11, length L1 of core 232 and length L2 of opposite core 232 in the width direction perpendicular to the moving direction of fixing belt 210 are configured to have a length of maximum paper pass region width Wmax of fixing belt 210 or greater.

With fixing belt 210 as the heating element in fixing apparatus 900 according to Embodiment 6, electric resistance is increased by thinning a non-magnetic material including, for example, copper and silver to about 10 μm, and heat is effectively produced by induced current. Further, fixing belt 210 is non-magnetic, and the magnetic flux therefore passes through fixing belt 210. Since this fixing belt 210 transmits the magnetic flux, it is possible to arrange opposite core 233 on the opposite side to excitation coil 231 with respect to fixing belt 210. It is thereby possible to obtain a strong magnetic flux between core 232 and opposite core 233, each using ferromagnetic ferrite.

Herein, with fixing belt 210, the clearance with core 232 tends to change due to decentering and the like during rotation. In contrast to this, core 232 and opposite core 233 are secured to respective predetermined positions and do not change relative positions.

Accordingly, in fixing apparatus 900 according to Embodiment 6, the magnetic flux between core 232 and opposite core 233 hardly changes, and fixing belt 210 transmits the magnetic flux and does not influence the magnetic flux, so that the magnetic flux penetrating fixing belt 210 does not change. In other words, even when fixing belt 210 rotates and the clearance between core 232 and fixing belt 210 changes, fixing belt 210 is able to maintain a predetermined heating value stably.

Although with the conventional example, a path of the magnetic flux generated around the coil is formed of the core and heating element, and the magnetic flux therefore changes according to the positions of the heating element, with the present invention, a path of the magnetic flux is formed of the core and opposite core, and the magnetic flux is therefore constant irrespective of the position of the heating element, thereby obtaining stable heat.

Further, although decreases in temperature occur at both end portions in the width direction of fixing belt 210 due to the influence of heat radiation, with fixing apparatus 900 according to Embodiment 6, as shown in FIG. 11, length L1 of core 232 and length L2 of opposite core 232 in the width direction perpendicular to the moving direction of fixing belt 210 are configured to be longer than the maximum paper pass region width Wmax of fixing belt 210, for example, by 10 mm or greater on one side. By this means, the temperature inside the maximum paper pass region width Wmax of fixing belt 210 is not influenced by heat radiation, so that it is possible to maintain the fixing temperature within a predetermined range. Herein, the fixing temperature within the predetermined range is, for example, 170±5 degrees when non-fixed toner image 111 is a color image, and is 190±10 degrees when non-fixed toner image 111 is a monochrome image.

As described above, with fixing apparatus 900 according to Embodiment 6, length L1 of core 232 and length L2 of opposite core 232 are configured to be longer than maximum paper pass region width Wmax of fixing belt 210 or greater, and the temperature distribution inside maximum paper pass region width Wmax of fixing belt 210 is therefore uniformly maintained, thereby obtaining stable fixing characteristics.

Further, with fixing apparatus 900 according to Embodiment 6, fixing belt 210 transmits the magnetic flux and does not influence the magnetic flux, and the magnetic flux between core 232 and opposite core 233 hardly changes, so that it is possible to maintain the temperature of fixing belt 210 uniformly and stably even when the clearance between core 232 and fixing belt 210 changes by decentering and vibration of fixing belt 210.

### EMBODIMENT 7

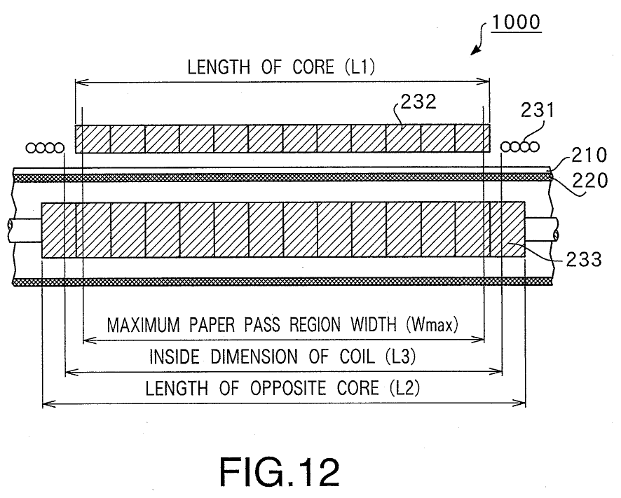

Next, a fixing apparatus according to Embodiment 7 of the present invention will be described. FIG. 12 is a schematic cross-sectional view illustrating a configuration of principal part of the fixing apparatus according to Embodiment 7 of the present invention.

As shown in FIG. 12, in fixing apparatus 1000 according to Embodiment 7, length L1 of core 232 in the width direction perpendicular to the moving direction of fixing belt 210 is configured to be almost as long as the length of maximum paper pass region width Wmax of fixing belt 210.

Further, in fixing apparatus 1000 according to Embodiment 7, length L2 in the width direction of opposite core 233 is formed to be longer than length L1 of core 232. Furthermore, length L2 in the width direction of opposite core 233 is formed to be longer than an inner diameter dimension (hereinafter, referred to as an “inside dimension”) L3 in the width direction of excitation coil 231.

Thus, in fixing apparatus 1000 according to Embodiment 7, length L2 in the width direction of opposite core 233 is formed to be longer than length L1 of core 232 or inside dimension L3 of the coil, the heating value of fixing belt 210 increases in portions corresponding to folded portions (both end portions in the width direction) of excitation coil 231.

By this means, with fixing apparatus 1000 according to Embodiment 7, it is possible to compensate for decreases in temperature at the both end portions in the width direction of fixing belt 210 due to heat radiation, and make core 232 or inside dimension L3 of the coil almost the same length as maximum paper pass region width Wmax of fixing belt 210, thereby reducing the size of the apparatus body.

Further, like fixing belt 210 according to Embodiments 1 and 6, fixing belt 210 of fixing apparatus 1000 is made of a thin non-magnetic material through which the magnetic flux passes. Accordingly, with this fixing apparatus 1000, even when the clearance between core 232 and fixing belt 210 changes by decentering and/or vibration of fixing belt 210, the magnetic flux between core 232 and opposite core 233 hardly changes, so that it is possible to maintain the temperature of fixing belt 210 uniformly and stably.

### EMBODIMENT 8

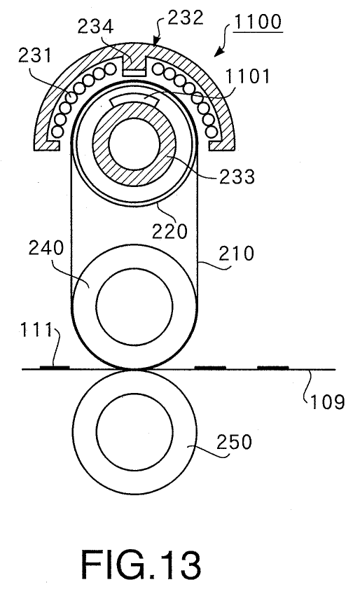

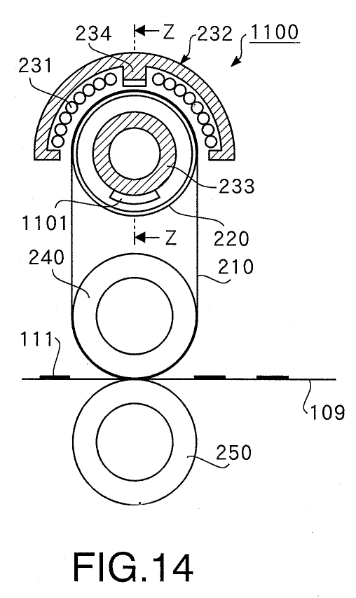

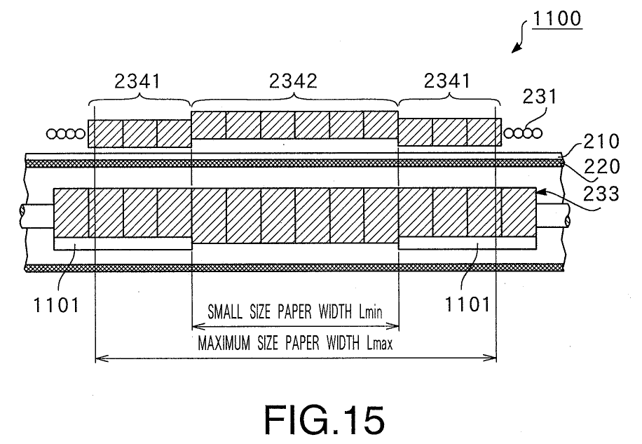

Next, a fixing apparatus according to Embodiment 8 of the present invention will be described. FIG. 13 is a schematic cross-sectional view illustrating a configuration of the fixing apparatus according to Embodiment 8 of the present invention. FIG. 14 is a schematic cross-sectional view illustrating an operation mode of the fixing apparatus according to Embodiment 8 of the present invention. FIG. 15 is a schematic cross-sectional view of principal part of the fixing apparatus according to Embodiment 8 of the present invention taken along line Z-Z shown in FIG. 14.

As shown in FIGS. 13, 14 and 15, fixing apparatus 1100 according to Embodiment 8 adopts a configuration where magnetic shield 1101 that shields the magnetic flux corresponding to a non-paper pass region in small size paper of fixing belt 210 is disposed in part of the outer circumference of opposite core 233.

Magnetic shied 1101 of this example is made of a conductive member including, for example, copper of a thickness of 1 mm. Magnetic shield 1101 has a sufficient thickness more than a skin depth, and the electric resistance therefore decreases and the eddy current is more likely to flow. By this means, the repulsion magnetic field increases, and the magnetic flux are thereby shielded.

Further, by rotation of opposite core 233 by a driving means (not shown), magnetic shield 1101 is able to change positions between a shield position to shield a magnetic path between center core 234 and opposite core 233 as shown in FIG. 13 and a withdrawal position for withdrawal from the magnetic path as shown in FIG. 14.

Herein, as shown in FIG. 15, center core 234 is formed to have a length corresponding to maximum size paper width (for example, recording paper of A3 size) Lmax. Further, magnetic shield 1101 has a length where the magnetic flux acting on the non-paper pass region of fixing belt 210 can be shielded when recording paper 109 having the width of small size paper (for example, the width of A4 size recording paper) Lmin is passed through a nip portion between fixing belt 210 and pressure roller 250.

With this fixing apparatus 1100 of this example, only by rotating opposite core 233, it is possible to switch the width in the longitudinal direction of the magnetic path between center core 234 and opposite core 233 between the width of maximum size paper Lmax and the width of small size paper Lmin, so that it is thus possible to support the width of recording paper 109 passed through the heating width of fixing belt 210 without difficulty.

However, with fixing apparatus 1100 having above-mentioned magnetic shield 1101, when recording paper 109 having the maximum size paper width Lmax is passed through (FIG. 14), heat is transferred from support roller 220 to magnetic shield 1101, and there is therefore a tendency that the temperatures at both ends in the paper pass region corresponding to magnetic shield 1101 is lower than the temperature in the center of the paper pass region that does not correspond to magnetic shield 1101.

Then, with fixing apparatus 1100 of this example, as shown in FIG. 15, center core 2341 in the portion opposite to magnetic shield 1101 are disposed in positions closer to opposite core 233 than center core 2342 in the position that is not opposite to magnetic shield 1101.

Thus, with fixing apparatus 1100 of this example, the gap between core 232 and opposite core 233 in portions corresponding to the position of magnetic shield 1101 is narrowed, so that the heating value of fixing belt 210 in portions corresponding to the position of magnetic shield 1101 is increased, thereby compensating for decreases in temperature due to magnetic shield 1101, and uniforming the heating temperature of fixing belt 210.

As described above, with fixing apparatuses 900, 1000, and 1100 according to Embodiments 6 to 8 of the present invention, respectively, core 232 and opposite core 233 have the sizes to heat a maximum paper pass region Wmax of fixing belt 210 through which recording paper 109 of a maximum size is passed to a fixing temperature within a predetermined range, so that it is possible to maintain the temperature of fixing belt 210 uniformly and stably.

Further, with fixing apparatuses 900, 1000, and 1100 according to Embodiments 6 to 8 of the present invention, respectively, changes in the clearance between fixing belt 210 and core 232 due to decentering and vibration of fixing belt 210 do not have an adverse effect on heating of fixing belt 210.

Thus, fixing apparatuses 900, 1000, and 1100 according to Embodiments 6 to 8, respectively, are distinguished from the conventional fixing apparatus where the clearance between the heating element and core changes by decentering and vibration of the heating element during rotational moving, and a heating value of the heating element changes and uneven temperatures tend to occur in the heating element. In other words, with fixing apparatuses 900, 1000, and 1100 according to Embodiments 6 to 8, respectively, it is possible to suppress uneven heating in the heating element due to decentering and vibration of the heating element and decreases in temperature due to heat radiation from the both end portions in the width direction of heating element, thereby maintaining the temperature of the heating element uniformly and stably. A fixing apparatus according to a first aspect of Embodiments 6 to 8 adopts a configuration provided with: a magnetic flux generating means that generates a magnetic flux using a coil wound around a core made of a magnetic material; an opposite core that is disposed opposite to the core to form a magnetic path to the core; and a heating element made of a non-magnetic material that moves in an across direction of the magnetic path to be induction-heated, where the magnetic flux generator and the opposite core have the sizes to heat a maximum paper pass region of the heating element through which a recording medium of a maximum size is passed to a fixing temperature within a predetermined range. Further, in the above-mentioned configuration, a fixing apparatus according to a second aspect of Embodiments 6 to 8 may have a configuration where lengths of the core and the opposite core in the width direction perpendicular to the moving direction of the heating element are a maximum paper pass region width of the heating element or greater. Furthermore, in the above-mentioned configuration, with a fixing apparatus according to a third aspect of Embodiments 6 to 8, the length in the width direction of the opposite core may be formed longer than in the core. Still furthermore, in the above-mentioned configuration, a fixing apparatus according to a fourth aspect of Embodiments 6 to 8 may have a configuration where the length in the width direction of the opposite core is formed to be longer than an inner diameter dimension in the width direction of the coil. Moreover, in the above-mentioned configuration, a fixing apparatus according to a fifth aspect of Embodiments 6 to 8 may have a configuration where a magnetic shield that shields the magnetic flux corresponding to a non-paper pass region of the heating element is provided in the opposite core. Further, in the above-mentioned configuration, with a fixing apparatus according to a sixth aspect of Embodiments 6 to 8, the magnetic shield may be made of anon-magnetic conductive material. Furthermore, in the above-mentioned configuration, with a fixing apparatus according to a seventh aspect of Embodiments 6 to 8, a configuration may be where a gap between the core and opposite core corresponding to a portion where the magnetic shield is smaller than a gap between the core and opposite core corresponding to a portion where the magnetic shield is not provided. Further, in the above-mentioned configuration, a fixing apparatus according to an eighth aspect of Embodiments 6 to 8 may have a configuration where the heating element is formed in the shape of a ring, and the coil is provided in an outer circumferential portion of the heating element. Furthermore, in the above-mentioned configuration, a fixing apparatus according to a ninth aspect of Embodiments 6 to 8 may have a configuration where, in the state where the coil is opposite to the heating element, inductance of the coil at a frequency of 30 kHz ranges from 10 μH to 50 μH, and electric resistance ranges from 0.5Ω to 5Ω. Moreover, in the above-mentioned configuration, a fixing apparatus according to a tenth aspect of Embodiments 6 to 8 may have a configuration where a frequency of a current applied to the coil ranges from 20 kHz to 100 kHz. Further, an image forming apparatus according to an eleventh aspect of Embodiments 6 to 8 is an image forming apparatus provided with a fixing means that fixes a non-fixed image formed on a recording medium, and may have a configuration that the fixing apparatus as described in any one of the first to tenth aspects of Embodiments 6 to 8 is used as the fixing means.

According to Embodiments 6 to 8, the magnetic flux generating means and the opposite core have the sizes to heat a maximum paper pass region of the heating element through which a recording medium of a maximum size is passed to a fixing temperature within a predetermined range, so that it is possible to maintain the temperature of the maximum paper pass region of the heating element uniformly and stably. Since the heating element is made of a thin non-magnetic material through which a magnetic flux is passed, changes in the clearance between the heating element and core due to decentering and vibration of the heating element do not have an adverse effect on heating of the heating element.

Fixing apparatuses according to Embodiments 6 to 8 are able to suppress uneven heating in the heating element due to decentering and vibration of the heating element, and decreases in temperature due to heat radiation from the both end portions in the width direction of heating element, and to maintain the temperature of the heating element uniformly and stably, and, therefore, are useful as a fixing apparatus of an image forming apparatus including, for example, an electrophotographic or electrostatic recording copy machine and facsimile, printer.

Further, with the fixing apparatus according to the embodiments of the present invention, fixing belt 210 as the heating element is formed in the shape of a ring, and excitation coil 231 is provided in an outer circumferential portion of fixing belt 210, so that operation efficiency in replacement and maintenance of fixing belt 210 is improved.

Furthermore, with the fixing apparatus according to the embodiments of the present invention, it is preferable that, in the state where excitation coil 231 is opposite to fixing belt 210, inductance of excitation coil 231 at a frequency of 30 kHz ranges from 10 μH to 50 μH, and electric resistance ranges from 0.5Ω to 5Ω. By this means, it is possible to use an inexpensive circuit with versatility as an excitation circuit of excitation coil 231.

Still furthermore, in the fixing apparatus according to the embodiments of the present invention, it is preferable that the current applied to excitation coil 231 has a frequency ranging from 20 kHz to 100 kHz. It is thereby possible to minimize the loss of power supply of excitation 231, and the operational efficiency improves.

The present application is based on Japanese Patent Applications No. 2004-334996 filed on Nov. 18, 2004, and No. 2004-336529 filed on Nov. 19, 2004, the entire contents of which are expressly incorporated by reference herein.

### INDUSTRIAL APPLICABILITY

The fixing apparatus according to the present invention is capable of maintaining the temperature of the heating element uniformly and stably even when the clearance between the heating element and core changes due to decentering and vibration of the heating element, and, therefore, is useful as a fixing apparatus of an image forming apparatus including, for example, an electrophotographic or electrostatic recording copy machine, facsimile and printer.

1. A fixing apparatus comprising:
a magnetic flux generating section that generates a magnetic flux using a coil wound around a core made of a magnetic material;
an opposite core that is disposed opposite to the core and forms a magnetic path to the core;
a heating element made of a non-magnetic material that moves in an across direction of the magnetic path and is induction-heated; and
a magnetic flux enhancement section that enhances the magnetic flux at both end portions in a width direction higher than the magnetic flux in a center portion in the width direction perpendicular to a moving direction of the heating element.

2. The fixing apparatus according to claim 1, wherein a magnetic shield that shields the magnetic flux corresponding to a non-paper pass region of the heating element is disposed in the opposite core, and
the magnetic flux enhancement section enhances the magnetic flux in a portion where the magnetic shield is disposed.

3. The fixing apparatus according to claim 1, wherein the magnetic flux enhancement section has a configuration where the cross-sectional area at both end portions in the width direction of the opposite core is made larger than the cross-sectional area in the center portion in the width direction of the opposite core to enhance the magnetic flux at the both end portions in the width direction.

4. The fixing apparatus according to claim 1, wherein the core has a center core disposed in a center portion of the coil, and the magnetic flux enhancement section has a configuration where the cross-sectional area at both end portions in the width direction of the center core is made larger than the cross-sectional area in the center portion in the width direction of the center core to enhance the magnetic flux at the both end portions in the width direction.

5. The fixing apparatus according to claim 1, wherein the magnetic flux enhancement section has a configuration where a gap between both end portions in the width direction of the core and the opposite core is made smaller than a gap between the center portion in the width direction of the core and the opposite core to enhance the magnetic flux at the both end portions in the width direction.

6. The fixing apparatus according to claim 1, wherein the core has a pair of side cores disposed at opposite side portions of the coil, and the magnetic flux enhancement section has a configuration where the cross-sectional areas at both end portions in the width direction of the side cores are made larger than the cross-sectional area in the center portion in the width direction of the side cores to enhance the magnetic flux at the both end portions in the width direction.

7. A fixing apparatus comprising:
a magnetic flux generator that generates a magnetic flux using a coil wound around a core made of a magnetic material;
an opposite core that is disposed opposite the core to form a magnetic path to the core; and
a heating element made of a non-magnetic material that moves in an across direction of the magnetic path to be induction-heated,
wherein the magnetic flux generating section and the opposite core have sizes to heat a maximum paper pass region of the heating element through which a maximum size recording medium is passed to a fixing temperature within a predetermined range.

8. The fixing apparatus according to claim 7, wherein lengths of the core and the opposite core in the width direction perpendicular to the moving direction of the heating element are more than or equal to a maximum paper pass region width of the heating element.

9. The fixing apparatus according to claim 7, wherein the length in the width direction of the opposite core is formed to be longer than in the core.

10. The fixing apparatus according to claim 7, wherein the length in the width direction of the opposite core is formed to be longer than an inner diameter dimension in the width direction of the coil.

11. The fixing apparatus according to claim 7, wherein a magnetic shield that shields the magnetic flux corresponding to a non-paper pass region of the heating element is disposed in the opposite core.

12. The fixing apparatus according to claim 1, wherein the heating element is formed in a shape of a ring, and the coil is placed in an outer circumferential portion of the heating element.

13. The fixing apparatus according to claim 1, wherein, in a state where the coil is opposite to the heating element, inductance of the coil at a frequency of 30 kHz ranges from 10 μH to 50 μH, and electric resistance ranges from 0.5Ω to 5Ω.

14. The fixing apparatus according to claim 1, wherein a frequency of a current applied to the coil ranges from 20 kHz to 100 kHz.

15. An image forming apparatus comprising a fixing section that fixes a non-fixed image formed on a recording medium, wherein the fixing apparatus according to claim 1 is used as the fixing section.

16. An image forming apparatus comprising a fixing section that fixes a non-fixed image formed on a recording medium, wherein the fixing apparatus according to claim 7 is used as the fixing section.
